(19) United States
(12) Patent Application Publication
(10) Pub. No.: US 2009/0163622 A1
(43) Pub. Date: Jun. 25, 2009

(54) Copolymers Based On Unsaturated Monocarboxylic or Dicarboxylic Acid Derivatives and Oxyalkylene Glycol Alkenyl Ethers, Process for Preparing Them and Their Use

(76) Inventors: Gerhard Albrecht, Tacherting (DE); Klaus Lorenz, Zangberg (DE); Christian Scholz, Trostberg (DE); Petra Wagner, Trostberg (DE)

Correspondence Address: FULBRIGHT & JAWORSKI, LLP, 666 FIFTH AVE, NEW YORK, NY, 10103-3198, US

(21) Appl. No.: 12/084,665

(22) PCT Filed: Dec. 20, 2006
(86) PCT No.: PCT/EP2006/012351

§ 371 Date: May 7, 2008

(30) Foreign Application Priority Data
Dec. 21, 2005 (DE) 102005061153.2

(51) Int. Cl. C08F 220/00; C08F 222/04; C08F 216/12; C08K 3/00; C08K 3/30

(52) U.S. Cl. 524/5; 526/271; 526/317.1; 526/303.1; 524/423

(57) ABSTRACT

Copolymers based on unsaturated mono- or dicarboxylic acid derivatives, oxyalkylene glycol alkenyl ethers and optionally vinylic polyalkylene glycol or ester compounds are described and also their use as additives for aqueous suspensions based on mineral or bituminous binders, in particular cement, gypsum, lime, anhydrite, or other calcium sulphate-based binders, and based on pulverulent dispersion binders. The copolymers according to the invention impart to the aqueous binder suspensions a very good dispersing and liquefying action with, at the same time, simultaneous excellent processing properties. Moreover, the oxyalkylene glycol alkenyl ethers according to the invention are industrially relatively simple and inexpensive to prepare and need comparatively low initiator concentrations in the copolymerization.

The present invention relates to copolymers based on unsaturated mono- or dicarboxylic acid derivatives and oxyalkylene glycol alkenyl ethers, to processes for their preparation and to the use of these copolymers as additives for aqueous suspensions based on mineral or bituminous binders.

It is known that additives in the form of dispersing agents are often added to aqueous suspensions of hydraulic binders for improving their processability, i.e. kneadability, spreadability, sprayability, pumpability or flowability. These additives, as a rule comprising ionic groups, are able to break up solid agglomerates, to disperse the particles formed and in this way to improve the processability, especially of highly concentrated suspensions. This effect is specifically utilized in the preparation of construction material mixtures, based on cement, lime and calcium sulphate-based hydraulic binders, if appropriate also as a mixture with organic (e.g. bituminous) fractions and furthermore for ceramic compounds, refractory compounds and oilfield construction materials.

In order to convert these construction material mixtures based on the said binders into a ready-to-use, processable form, as a rule significantly more mixing water is necessary than would be necessary for the subsequent hydration or hardening process. The cavity content formed by the excess water later evaporating in the construction article leads to significantly worsened mechanical strengths and resistances.

In order to reduce this excess water content in the case of a specified processing consistency and/or to improve the processability in the case of a specified water/binder ratio, additives are employed which are in general designated as water reduction or flow agents. As such agents, poly-condensation products based on naphthalene- or alkylnaphthalenesulphonic acids (cf. EP-A 214 412) or melamine-formaldehyde resins comprising sulphonic acid groups (cf. DE-C 16 71 017) are especially known.

A disadvantage with these additives is the fact that their excellent liquefying action, in particular in concrete construction, only lasts for a short period of time. The decrease in the processability of concrete mixtures (“slump loss”) in a short time can in particular lead to problems where there is a large period between preparation and installation of the fresh concrete, for example due to long conveyor and transport routes.

An additional problem results with the application of such flow agents in mining and in the interior zone (plasterboard sheet drying, anhydrite flow coat applications, concrete finished part production), where the release of the toxic formaldehyde contained in the products due to preparation and thus considerable industrial hygiene pollution can occur. For this reason, it has also already been attempted instead of this to develop formaldehyde-free concrete flow agents from maleic acid monoesters and styrene, for example according to EP-A 306 449. The flow action of concrete mixtures can be maintained for an adequately long period of time with the aid of these additives, but the originally present, very high dispersing action is very rapidly lost after storage of the aqueous preparation of the flow agent, due to the hydrolysis of the polymeric ester.

This problem does not occur according to EP-A 373 621 in flow agents consisting of alkylpolyethylene glycol allyl ethers and maleic anhydride. However, these products, similarly to those previously described, are surface-active compounds which introduce undesirably high contents of air pores into the concrete mixture, from which losses in the strength and resistance of the hardened construction material result.

For this reason, it is necessary to add to the aqueous solutions of these polymer compounds antifoams, such as, for example, tributyl phosphate, silicone derivatives and various water-insoluble alcohols in the concentration range from 0.1 to 2% by weight based on the solids content. The mixing in of these components and the maintenance of a storage-stable homogeneous form of the corresponding formulations also itself then turns out to be quite difficult if these antifoams are added in the form of emulsions.

As a result of the complete or at least partial incorporation of a defoaming or anti-air-introducing structural unit into the copolymer, the problem of demixing according to DE 195 13 126 A1 can be solved.

It has been shown, however, that the high effectiveness and the low “slump-loss” of the copolymers described here often leads to inadequate 24 hour strengths of the concrete. Such copolymers, in particular, do not have the optimal properties, where with the lowest possible water content a particularly densely formed and therefore high-strength and highly resistant concrete should be produced and steam hardening (finished part industry) for the acceleration of the hardening process should be dispensed with.

For the solution of this problem, according to DE 199 26 611 A1 copolymers of unsaturated mono- or dicarboxylic acid derivatives and oxyalkylene glycol alkenyl ethers were proposed, which at a low dose can long maintain the processability of highly concentrated construction material mixtures in practice, with a simultaneously increased strength in the hardened state of the construction material due to an extreme lowering of the water/binder ratio. However, it has proved disadvantageous that the corresponding copolymers can only be prepared with relatively short polymer chains and a comparatively low average molecular weight, which is why the dispersing action of these copolymers was not optimal hitherto.

The present invention was therefore based on the object of making available novel copolymers which did not have the said disadvantages according to the prior art, but on account of long polymer chains and high average molecular weight show an improved dispersing and liquefying action.

This object was achieved according to the invention by the copolymers according to Claim 1. It has in fact surprisingly been shown that the products according to the invention based on unsaturated mono- or dicarboxylic acid derivatives and oxyalkylene glycol alkenyl ethers impart a very good dispersing and liquefying action with, at the same time, excellent processing properties to aqueous binder suspensions. Moreover, the oxyalkylene glycol alkenyl ethers employed according to the invention are industrially relatively simple and inexpensive to prepare and need comparatively low initiator concentrations in copolymerization, which was likewise unforeseeable.

The copolymers according to the present invention contain at least two, preferably three, structural groups a), b) and optionally c) and optionally d) and no other structural groups. The first structural group a) is a mono- or dicarboxylic acid derivative having the general formulae (Ia) and/or (Ib).

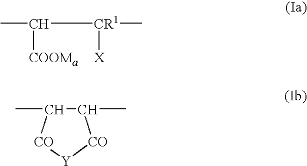

In the mono- or dicarboxylic acid derivative (Ia), R¹ represents hydrogen or an aliphatic hydrocarbon radical having 1 to 20 C atoms, preferably a methyl group. X is H, —COOMₐ, —CO—O—(CₘH₂ₘO)ₙ—R² or —CO—NH—(CₘH₂ₘO)ₙ—R² with the following meaning for M, a, m, n and R²:

M is hydrogen, a mono- or divalent metal cation (preferably a sodium, potassium, calcium or magnesium ion), ammonium, an organic amine radical, and a=½ or 1, depending on whether M is a mono- or divalent cation. The organic amine radicals employed are preferably substituted ammonium groups which are derived from primary, secondary or tertiary C₁₋₂₀-alkylamines, C₁₋₂₀-alkanolamines, C₅₋₈-cycloalkylamines and C₈₋₁₄-arylamines. Examples of the corresponding amines are methylamine, dimethylamine, trimethylamine, ethanolamine, diethanolamine, triethanolamine, methyldiethanolamine, cyclohexylamine, dicyclohexylamine, phenylamine, diphenylamine in the protonated-(ammonium) form.

R² is hydrogen, an aliphatic hydrocarbon radical having 1 to 20 C atoms, a cycloaliphatic hydrocarbon radical having 5 to 8 C atoms, an aryl radical having 6 to 14 C atoms, which can optionally be additionally substituted, m=2 to 4 and n=0 to 200, preferably 1 to 150. The aliphatic hydrocarbons can in this case be linear or branched and saturated or unsaturated. Preferred cycloalkyl radicals are to be regarded as cyclopentyl or cyclohexyl radicals, preferred aryl radicals as phenyl or naphthyl radicals, which in particular can additionally be substituted by hydroxyl, carboxyl or sulphonic acid groups.

Instead of or in addition to the mono- or dicarboxylic acid derivative according to formula (Ia), the structural group a) can also be present in cyclic form according to formula (Ib), where Y can be ═O (acid anhydride) or NR² (acid imide) with the meaning designated above for R².

The second structural group b) corresponds to formula (II)

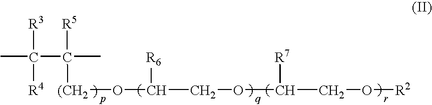

where R³=H, an aliphatic hydrocarbon radical having 1 to 6 C atoms, R⁴=an aliphatic hydrocarbon radical having 1 to 6 C atoms, a cycloaliphatic hydrocarbon radical having 5 to 8 C atoms and phenyl, R⁵=H, an aliphatic hydrocarbon radical having 1 to 5 C atoms, R⁶, R⁷ independently from each other ═H, an aliphatic hydrocarbon radical having 1 to 6 C atoms, p=0 to 3, q+r=0 to 500 and R² has the abovementioned meaning.

According to a preferred embodiment, p in formula (II) can be 0; i.e. vinyl polyalkoxylates are concerned.

The third structural group c) corresponds to the formulae (IIIa) or (IIIb)

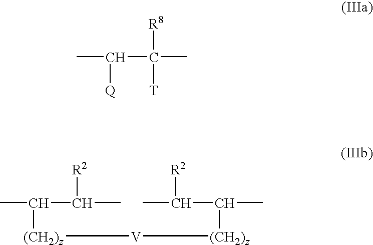

In formula (IIIa), R⁸ can be ═H or CH₃, depending on whether acrylic or methacrylic acid derivatives are concerned. Q can in this case be —H, —COOₐM or —COOR⁹, where a and M have the abovementioned meaning and R⁹ can be an aliphatic hydrocarbon radical having 3 to 20 C atoms, a cycloaliphatic hydrocarbon radical having 5 to 8 C atoms or an aryl radical having 6 to 14 C atoms. The aliphatic hydrocarbon radical can likewise be linear or branched, saturated or unsaturated. The preferred cycloaliphatic hydrocarbon radicals are in turn cyclopentyl or cyclohexyl radicals and the preferred aryl radicals phenyl or naphthyl radicals. If T=—COOR⁹, Q=—COOaM or —COOR⁹. In the case where T and Q=—COOR⁹, the corresponding structural groups are derived from the dicarboxylic acid esters.

In addition to these ester structural units, the structural groups c) can have still other hydrophobic structural elements. These include the polypropylene oxide and polypropylene oxide-polyethylene oxide derivatives with

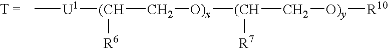

x in this case assumes a value from 1 to 150 and y from 0 to 15. The alkylene oxide derivatives can in this case be linked via a group U¹ to the alkyl radical of the structural group c) according to formula (IIIa), where U¹ can be =—CO—NH—, —O— or —CH₂—O—. In this case, the corresponding amide, vinyl or allyl ethers of the structural group according to formula (IIIa) are concerned. R¹⁰ can in this case in turn be R² (for meaning of R² see above) or

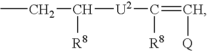

where U² can be =—NH—CO—, —O—, or —OCH₂— and Q has the meaning described above. These compounds are polyalkylene oxide derivatives of the bifunctional alkenyl compounds according to formula (IIIa).

As further hydrophobic structural elements, the structural groups c) can additionally contain compounds according to the formula (IIIa) having T=(CH₂)_{z}—V—(CH₂)ₙ—CH═CH—R², where z=0 to 4 and V can be an —O—CO—C₆H₄—CO—O-radical and R² has the meaning indicated above. In this case, the corresponding difunctional ethylene compounds according to the formula (IIIa) are concerned, which are linked to one another via ester groups of the formula —O—CO—C₆H₄—CO—O— and where only one ethylene group has been copolymerized. These compounds are derived from the corresponding dialkenylphenyldicarboxylic acid esters.

It is also possible in the context of the present invention that not only one, but both ethylene groups of the difunctional ethylene compounds have been copolymerized. This corresponds essentially to the structural groups according to the formula (IIIb)

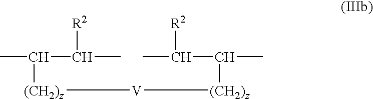

where R², V and z have the meaning already described.

It is to be regarded as essential to the invention that the copolymers contain 10 to 90 mol % of structural groups of the formulae (Ia) and/or (Ib), 1 to 89 mol % of structural groups of the formula (II), 0 to 10 mol % of structural groups of the formulae (IIa) and/or (IIIb).

Preferably, these polymers contain 40 to 75 mol % of structural groups of the formulae (Ia) and/or (Ib), 20 to 55 mol % of structural groups of the formula (II), 1 to 5 mol % of structural groups of the formulae (IIIa) and/or (IIIb).

According to a preferred embodiment, the copolymers according to the invention additionally contain up to 50 mol %, in particular up to 20 mol % based on the sum of the structural groups a) to c), of structures which are based on monomers based on vinyl- or (meth)acrylic acid derivatives such as styrene, α-methylstyrene, vinyl acetate, vinyl propionate, ethylene, propylene, isobutene, N-vinylpyrrolidone, allylsulphonic acid, methallylsulphonic acid, vinylsulphonic acid or vinylphosphonic acid.

Preferred monomeric (meth)acrylic acid derivatives are hydroxyalkyl (meth)acrylate, acrylamide, methacrylamide, AMPS, methyl methacrylate, methyl acrylate, butyl acrylate or cyclohexyl acrylate.

The number of repeating structural units in the copolymers is not restricted. It has proved particularly advantageous, however, to set average molecular weights of 5000 to 100 000 g/mol.

The preparation of the copolymers according to the invention can be carried out in various ways. It is important in this case that 10 to 90 mol % of an unsaturated mono- or dicarboxylic acid derivative, 1 to 89 mol % of an oxyalkylene alkenyl ether and 0 to 10 mol % of a vinylic polyalkylene glycol or ester compound are polymerized with the aid of a free-radical starter.

Unsaturated mono- or dicarboxylic acid derivatives which form the structural groups of the formulae (Ia) and (Ib) preferably employed are: acrylic acid, methacrylic acid, maleic acid or fumaric acid.

Instead of acrylic acid, methacrylic acid, maleic acid or fumaric acid, their mono- or divalent metal salts, preferably sodium, potassium, calcium or ammonium salts, can also be used.

As the acrylic, methacrylic, maleic acid or fumaric acid, derivatives are especially used esters thereof with a polyalkylene glycol of the general formula HO—(CₘH₂ₘO)ₙ—R² having R²=H, an aliphatic hydrocarbon radical having 1 to 20 C atoms, a cycloaliphatic hydrocarbon radical having 5 to 8 C atoms, an optionally substituted aryl radical having 6 to 14 C atoms and m=2 to 4 and n=0 to 200.

The preferred substituents on the aryl radical are —OH, COO^{⊖} or —SO₃^{⊖} groups.

Instead of maleic acid, its anhydride or imide can also be used. The derivatives of the formulae (Ia) and (Ib) can also be present as a mixture of anhydride or imide and free acid and are used in an amount of preferably 40 to 75 mol %.

The second component essential to the invention for the preparation of the copolymers according to the invention is an oxyalkylene glycol alkenyl ether, which is preferably employed in an amount from 20 to 55 mol %. In the preferred oxyalkylene glycol alkenyl ethers according to the formula (V)

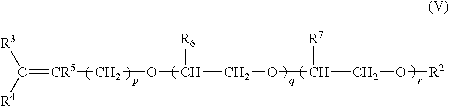

R³=H or is an aliphatic hydrocarbon radical having 1 to 6 C atoms, R⁴ is an aliphatic hydrocarbon radical having 1 to 6 C atoms, a cycloaliphatic hydrocarbon radical having 5 to 8 C atoms and phenyl, R⁵=H, an aliphatic hydrocarbon radical having 1 to 5 C atoms, R⁶ and R⁷ independently from each other ═H, an aliphatic hydrocarbon radical having 1 to 6 C atoms, p=0 to 3, q+r=0 to 500, while R² has the abovementioned meaning. In this case, the use of propenyloxy-polyalkylene glycol derivatives, which can be prepared very simply by rearrangement of the corresponding allyl polyethers, has proved particularly advantageous.

1 to 5 mol % of a vinylic polyalkylene glycol or ester compound are preferably employed as the third optional component for the introduction of the structural group c). The most preferred vinylic polyalkylene glycol compounds used are derivatives according to the formula (VI),

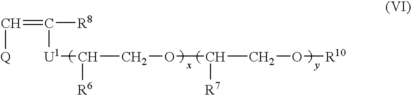

where Q can preferably be —H, or —COOₐM, R⁸=H, CH₃ and U¹=—CO—NH—, —O— or —CH₂O—, i.e. the acid amide, vinyl or allyl ether of the corresponding polyalkylene glycol derivatives is concerned. The values for x are 1 to 150 and for y=0 to 15. R¹⁰ can either again be R² or

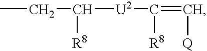

where U²=—NH—CO—, —O— and —OCH₂— and Q=—COOₐM and is preferably —H.

If R¹⁰=R² and R² is preferably H, the polyalkylene glycol monoamides or ethers of the corresponding acrylic (Q=H, R⁸=H), methacrylic (Q=H, R⁸=CH₃) or maleic acid (Q=—COOₐM-R⁸=H) derivatives are concerned. Examples of such monomers are maleic acid N-(methylpolypropylene glycol) monoamide, maleic acid N-(methoxypolypropylene glycol polyethylene glycol) monoamide, polypropylene glycol vinyl ether and polypropylene glycol allyl ether.

If R¹⁰≠R², bifunctional vinyl compounds are concerned whose polyalkylene glycol derivatives are bonded to one another by means of amide or ether groups (—O— or —OCH₂—). Examples of such compounds are polypropylene glycol bismaleic amide acid, polypropylene glycol diacrylamide, polypropylene glycol dimethacrylamide, polypropylene glycol divinyl ether, polypropylene glycol diallyl ether.

The vinyl ester compound employed in the context of the present invention is preferably derivatives according to the formula (VII),

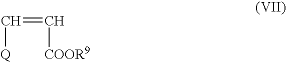

where Q=—COOₐM or —COOR⁹ and R⁹ can be an aliphatic hydrocarbon radical having 3 to 20 C atoms, a cycloaliphatic hydrocarbon radical having 5 to 8 C atoms and an aryl radical having 6 to 14 C atoms; a and M have the above-mentioned meaning. Examples of such ester compounds are di-n-butyl maleate or fumarate or mono-n-butyl maleate or fumarate.

In addition, compounds according to the formula (VIII) can also be employed

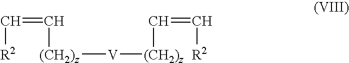

where z in turn can be 0 to 4 and R² has the already known meaning. V is in this case —O—CO—C₆H₄—CO—O—. These compounds are, for example, dialkenylphthalic acid derivatives. A typical example of such phthalic acid derivatives is diallyl phthalate.

The molecular weights of the compounds which form the structural group c) can be varied within wide limits and are preferably between 150 and 10 000.

According to the invention, it is possible according to a preferred embodiment for additionally up to 50, preferably up to 20, mol %, based on the sum of the structural groups a) to c), of further monomers as described above to be employed.

The copolymers according to the present invention can be prepared by the customary methods. A particular advantage according to the invention consists in the fact that it is possible to work without solvent or else in aqueous solution. In both cases, reactions which are pressureless and therefore quite safe in terms of safety are concerned.

If the process is carried out in aqueous solution, the polymerization takes place at 20 to 100° C. with the aid of a customary free-radical starter, the concentration of the aqueous solution preferably being adjusted to 30 to 50% by weight. According to a preferred embodiment, the free-radical polymerization can in this case be carried out in the acidic pH range, in particular at a pH between 4.0 and 6.5, where use can be made of the conventional initiators such as H₂O₂ without a feared ether cleavage occurring, by means of which the yields would be very severely reduced.

In the process according to the invention, a procedure is preferably used such that the unsaturated mono- or dicarboxylic acid derivative which forms the structural group a) is introduced in partly neutralized form in aqueous solution, preferably together with the polymerization initiator, and the other monomers are metered in as soon as the necessary reaction temperature is reached in the receiver. The polymerization auxiliaries, which can lower the activation threshold of the preferably peroxidic initiator, are added separately such that the copolymerization can proceed at relatively low temperatures. According to a further preferred embodiment, the unsaturated mono- or dicarboxylic acid derivative and also the free-radical former can be metered in at separate or common inlets of the reactor receiver, by means of which the problem of heat dissipation can be solved in an ideal manner.

On the other hand, it is also possible to introduce the polyalkylene glycol alkenyl ether forming the structural group b) and to meter in the mono- or dicarboxylic acid derivative (structural group a)) such that a uniform distribution of the monomer units over the polymer chain is achieved.

The type of polymerization initiators, activators and other auxiliaries used, such as, for example, molecular weight regulators, is relatively unproblematical, i.e. the initiators used are the customary free-radical donors, such as hydrogen peroxide, sodium, potassium or ammonium peroxodisulphate, tert-butyl hydroperoxide, dibenzoyl peroxide, sodium peroxide, 2,2′-azobis(2-amidino-propane) dihydrochloride, azobis(isobutyronitrile) etc. If redox systems are used, the abovementioned initiators are combined with activators having a reducing action. Examples of such reducing agents are Fe(II) salts, sodium hydroxymethanesulphinate dihydrate, alkali metal sulphites and metabisulphites, sodium hypophosphite, hydroxylamine hydrochloride, thiourea etc.

A particular advantage of the copolymers according to the invention is the fact that they can also be prepared without solvent, which can take place with the aid of the customary free-radical starters at temperatures between 20 and 150° C. For economical reasons, this variant can in particular be used when the copolymers according to the invention are to be supplied directly to their use according to the invention in anhydrous form, because then a laborious removal of the solvent, in particular of the water (for example by spray drying) can be omitted.

The copolymers according to the invention are outstandingly suitable as additives for aqueous suspensions of inorganic and organic solids based on mineral or bituminous binders such as cement, gypsum, lime, anhydrite or other calcium sulphate-based construction materials, or based on pulverulent dispersion binders, where they are employed in an amount from 0.01 to 10% by weight, in particular 0.1 to 5% by weight, based on the weight of the mineral binder.

The following examples are intended to explain the invention in more detail.

### EXAMPLES

### Preparation Examples

### Example 1

500.0 g (1.00 mol) of propenyloxypolyethylene glycol of the general formula (II) (average molecular weight 500 g/mol) were introduced into a 5 l double-walled reaction vessel containing a thermometer, stirrer, reflux condenser and two entries for separate feeds.

2.28 g (0.01 mol) of dibutyl maleate were stirred in and 500 g of tap water were subsequently added, a strongly alkaline aqueous solution of the vinyl ether being obtained.

350 mg of FeSO₄7H₂O, 1.99 g of 3-mercaptopropionic acid and 13.00 g of 50% strength aqueous hydrogen peroxide were added successively. Subsequently, 100.87 g (1.40 mol) of acrylic acid and 208.22 g (1.6 mol) of hydroxypropyl acrylate (HPA) dissolved in 350 g of tap water, comprising an additional regulator amount of 6.21 g of 3-mercaptopropionic acid, were added to the receiver mixture at room temperature over a period of 75 minutes. Separately to this, the metering of 85 ml of a 2% strength aqueous solution of Brüggolit™ took place over a period of 100 minutes, the temperature increasing to a maximum of 36.5° C.

After addition was complete, the mixture was stirred for a further 10 minutes and adjusted to a pH of 6.50 by addition of aqueous sodium hydroxide solution. The weight average molecular weight of the copolymer was 18800 g/mol.

### Example 2

500.0 g (1.00 mol) of propenyloxypolyethylene glycol 500 of the general formula (II) (average molecular weight 500 g/mol) were introduced into a 5 l double-walled reaction vessel containing a thermometer, stirrer, reflux condenser and two entries for separate feeds.

2.28 g (0.01 mol) of dibutyl maleate were stirred in and 500 g of tap water were subsequently added, a strongly alkaline aqueous solution of the vinyl ether being obtained.

29.40 g (0.30 mol) of maleic anhydride dissolved in 68.6 g of water (corresponding to a 30% strength solution) and separately 5.43 g of 20% strength aqueous sodium hydroxide solution were added with stirring and cooling, the temperature being kept below 30° C. 310 mg of FeSO₄7H₂O, 1.54 g of 3-mercaptopropionic acid and 11.00 g of 50% strength aqueous hydrogen peroxide were added successively. Subsequently, 100.87 g (1.40 mol) of acrylic acid dissolved in 150 g of tap water, comprising an additional regulator amount of 5.30 g of 3-mercaptopropionic acid, were added to the receiver mixture at room temperature over a period of 75 minutes. Separately to this, the metering of 72 ml of a 2% strength aqueous solution of Brüggolit™ took place over a period of 100 minutes, the temperature rising to a maximum of 34.9° C.

After addition was complete, the mixture was stirred for a further 10 minutes and adjusted to a pH of 6.50 by addition of aqueous sodium hydroxide solution. The weight average molecular weight of the copolymer was 20100 g/mol.

### Example 3

1100 g (1.00 mol) of propenyloxypolyethylene glycol 1100 of the general formula (II) (average molecular weight 1100 g/mol) were introduced as a melt at 70° C. into a 5 l double-walled reaction vessel containing a thermometer, stirrer, reflux condenser and two entries for separate feeds.

1100 g of tap water were added, a strongly alkaline aqueous solution of the vinyl ether being obtained. 19.60 g (0.20 mol) of maleic anhydride dissolved in 45.0 g of water (corresponding to a 30% strength solution) and separately 3.62 g of 20% strength aqueous sodium hydroxide solution were added with stirring and cooling, the temperature being kept below 30° C.

Subsequently, 36.00 g (0.02 mol) of a reaction product of a butanol-started monofunctional NH₂-terminated ethylene oxide/propylene oxide block polymer (EO 4, PO 27; molecular weight 1800 g/mol) with maleic anhydride were added with short-term intensive stirring and 310 mg of FeSO₄7H₂O, 1.60 g of 3-mercaptopropionic acid and 11.50 g of 50% strength aqueous hydrogen peroxide were added successively. Subsequently, 93.67 g (1.30 mol) of acrylic acid dissolved in 281 g of tap water comprising an additional regulator amount of 5.0 g of 3-mercaptopropionic acid were added to the receiver mixture at room temperature over a period of 75 minutes. Separately to this, the metering of 72 ml of a 2% strength aqueous solution of Brüggolit™ took place over a period of 97 minutes, the temperature rising to a maximum of 32.8° C. After addition was complete, the mixture was stirred for a further 15 minutes and adjusted to a pH of 6.50 by addition of aqueous sodium hydroxide solution. The weight average molecular weight of the copolymer was 30300 g/mol.

### Example 4

2000.0 g (1.00 mol) of propenyloxypolyethylene glycol 2000 of the general formula (II) (average molecular weight 2000 g/mol) were introduced as a melt at 50° C. into a 5 l double-walled reaction vessel containing a thermometer, stirrer, reflux condenser and two entries for separate feeds. 4.56 g (0.02 mol) of dibutyl maleate were stirred into the melt and subsequently 2000 g of tap water were added, a strongly alkaline aqueous solution of the vinyl ether being obtained.

Subsequently, 310 mg of FeSO₄7H₂O, 1.99 g of 3-mercaptopropionic acid and 12.00 g of 50% strength aqueous hydrogen peroxide were added. Subsequently, 144.12 g (2.00 mol) of acrylic acid were mixed at room temperature with 350 g of tap water, an additional regulator amount of 4.31 g of 3-mercaptopropionic acid being contained. This was added to the receiver mixture over a period of 85 minutes. Separately to this, the metering of 78 ml of a 2% strength aqueous solution of Brüggolit™ took place over a period of 97 minutes, the temperature rising to a maximum of 31.1° C.

After addition was complete, the mixture was stirred for a further 10 minutes and adjusted to a pH of 6.50 by addition of aqueous sodium hydroxide solution. The weight average molecular weight of the copolymer was 33300 g/mol.

### Example 5

2000 g (1.00 mol) of propenyloxypolyethylene glycol 2000 of the general formula (II) (average molecular weight 2000 g/mol) were introduced as a melt at 85° C. into a 5 l double-walled reaction vessel containing a thermometer, stirrer, reflux condenser and two entries for separate feeds.

Subsequently, 2000 g of tap water were added, a strongly alkaline aqueous solution of the vinyl ether being obtained. 58.80 g (0.60 mol) of maleic anhydride dissolved in 137.2 g of water (corresponding to a 30% strength solution) and separately 10.86 g of 20% strength aqueous sodium hydroxide solution were added with stirring and cooling, the temperature being kept below 30° C.

Subsequently, 36.00 g (0.02 mol) of a reaction product of a butanol-started monofunctional NH₂-terminated ethylene oxide/propylene oxide block polymer (EO 4, PO 27; molecular weight 1800 g) with maleic anhydride were added with short-term intensive stirring. Subsequently, 380 mg of FeSO₄7H₂O, 2.33 g of 3-mercaptopropionic acid and 13.50 g of 50% strength aqueous hydrogen peroxide were added. Subsequently, 128.27 g (1.78 mol) of acrylic acid dissolved in 350 g of tap water comprising an additional regulator amount of 6.31 g of 3-mercaptopropionic acid were added to the receiver mixture at room temperature over a period of 85 minutes. Separately to this, the metering of 91 ml of a 2% strength aqueous solution of Brüggolit™ took place over a period of 97 minutes, the temperature rising to a maximum of 30.9° C. After addition was complete, the mixture was stirred for a further 10 minutes and adjusted to a pH of 6.50 by addition of aqueous sodium hydroxide solution. The weight average molecular weight of the copolymer was 31200 g/mol.

### COMPARATIVE EXAMPLES

### Comparative Example 1

The procedure was as described in Example 1, but instead of the propenyloxypolyethylene glycol of the general formula (II) used there a vinyloxybutylpoly(ethylene glycol) having the average molecular weight 500 g/mol was used. Otherwise, the same required amounts as in Example 1 were used.

### Comparative Example 2

The procedure was as described in Example 5, but instead of the propenyloxypolyethylene glycol (MW=2000) of the general formula (II) used there a vinyloxybutylpoly(ethylene glycol) having the average molecular weight 2000 g/mol was used.

TABLE 1
Molar composition of the copolymers corresponding to the examples (monomer in mol %)

| | Vinyloxy- | Vinyloxy- | 1-Propenyl- | 1-Propenyl- | 1-Propenyl- | | | | | Poly(PO- | |
|---|---|---|---|---|---|---|---|---|---|---|---|
| | butylpoly- | butylpoly- | oxypoly- | oxypoly- | oxypoly- | | | | | block-EO)- | |
| | (ethylene | (ethylene | ethylene | ethylene | ethylene | | | Hydroxy- | | maleamic | |
| | glycol) | glycol) | glycol | glycol | glycol | Acryl- | Maleic | propyl | | acid | Mw |
| | (500 g/ | (2000 g/ | (500 g/ | (1100 g/ | (2000 g/ | ic | anhy- | acrylate | Dibutyl | (1900 g/ | (1000 g/ |
| Polymer | mol) | mol) | mol) | mol) | mol) | acid | dride | (HPA) | maleate | mol) | mol) |
| Comparative | 24.94 | — | — | — | — | 34.91 | — | 39.90 | 0.25 | — | 18 |
| example 1 | | | | | | | | | | | |
| (VP 1828) | | | | | | | | | | | |
| Comparative | — | 29.41 | | | | 52.36 | 17.64 | — | — | 0.59 | 33 |
| example 2 | | | | | | | | | | | |
| Melment L 10 | — | — | — | — | — | — | — | — | — | — | — |
| Example 1 | — | — | 24.94 | — | — | 34.91 | — | 39.90 | 0.25 | — | 19 |
| Example 2 | — | — | 36.90 | — | — | 51.66 | 11.07 | — | 0.37 | — | 20 |
| Example 3 | — | — | — | 39.68 | — | 51.59 | 7.94 | — | — | 0.79 | 30 |
| Example 4 | — | — | | — | 33.11 | 66.23 | — | — | 0.66 | — | 33 |
| Example 5 | — | — | — | | 29.41 | 52.35 | 17.65 | — | — | 0.59 | 31 |

### USE EXAMPLES

### Use Example 1

### Ready-Mixed Concrete

As standard, 4.5 kg of Portland cement (CEM 142.5 R Bernburg) were mixed with 33 kg of aggregates (grading curve 0 to 32 mm) and 2.7 kg of water including the water from the additive in a concrete mechanical mixer. The aqueous solutions of the additives were added and 10 minutes and 40 minutes after the beginning of the test the determination of the degree of spread was carried out according to DIN EN 12350-5.

Test bodies of edge length 15×15×15 cm were subsequently prepared and the compressive strength after 24 hours and the air pore content were determined (by means of density of the hardened sample).

TABLE 2
Ready-mixed concrete results (W/C = 0.6)

| | | | | | | 24 h |
|---|---|---|---|---|---|---|
| | | | Degree of | | | compressive |
| | Solid | Dosage | spread (cm) | | Air content | strength |
| Polymer | (% w/w) | (% w/w) | 10 min | 40 min | (% v/v) | (MPa) |
| Comparison 1 | 39.7 | 0.25 | 55.0 | 54.0 | 2.3 | 13.9 |
| (=VP 1828) | | | | | | |
| Comparison 2 | 40.0 | 0.25 | 62.0 | 58.0 | 2.5 | 15.0 |
| Melment L 10 | 40.3 | 0.55 | 55.5 | 40.5 | 1.5 | 14.8 |
| Ex. 1 | 42.9 | 0.25 | 58.0 | 57.5 | 2.3 | 14.2 |
| Ex. 2 | 41.2 | 0.25 | 60.5 | 58.5 | 2.3 | 15.9 |
| Ex. 3 | 39.9 | 0.25 | 60.0 | 59.0 | 2.4 | 14.9 |
| Ex. 4 | 43.0 | 0.25 | 61.5 | 59.5 | 2.6 | 15.5 |
| Ex. 5 | 44.6 | 0.25 | 65.0 | 60.5 | 2.3 | 16.5 |

### Use Example 2

### Finished Part Concrete

Finished part formulation as described above, but 5.75 kg of Portland cement CEM I 52.5 R Bernburg, 2.3 kg of water and 33 kg of aggregate.

TABLE 3
Finished part concrete results (W/C = 0.4)

| | | | | | | 24 h |
|---|---|---|---|---|---|---|
| | | | Degree of | | | compressive |
| | Solid | Dosage | spread (cm) | | Air content | strength |
| Polymer | (% w/w) | (% w/w) | 10 min | 40 min | (% v/v) | (MPa) |
| Comparison 1 | 39.7 | 0.3 | 53.0 | 51.0 | 1.6 | 38.8 |
| (=VP 1828) | | | | | | |
| Comparison 2 | 40.0 | 0.25 | 57.5 | 54.0 | 1.4 | 41.1 |
| Melment L 10 | 40.3 | 0.9 | 38.0 | — | 1.5 | 37.9 |
| Ex. 1 | 42.9 | 0.3 | 55.5 | 54.5 | 1.6 | 39.2 |
| Ex. 2 | 41.2 | 0.3 | 58.0 | 56.5 | 1.5 | 39.9 |
| Ex. 3 | 39.9 | 0.3 | 58.5 | 56.5 | 1.5 | 40.2 |
| Ex. 4 | 43.0 | 0.3 | 60.5 | 58.5 | 1.6 | 41.1 |
| Ex. 5 | 44.6 | 0.25 | 61.5 | 59.5 | 1.5 | 42.5 |

1-20. (canceled)

21. A copolymer based on unsaturated monocarboxylic or dicarboxylic acid derivatives and oxyalkylene glycol alkenyl ethers, the copolymer comprising:
a) 10 to 90 mol % of the structural groups of at least one of formula (Ia) or formula (Ib) 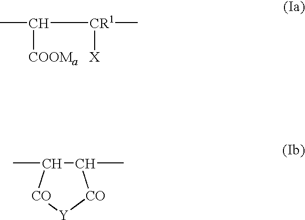
wherein
R¹ is hydrogen or an aliphatic hydrocarbon radical having 1 to 20 carbon atoms;
X is H, —COOMₐ, —CO—O(CₘH₂ₘO)ₙ—R² or —CO—NH—(CₘH₂ₘO)ₙ—R²;
M is hydrogen, a monovalent cation, a divalent metal cation, an ammonium ion or an organic amine radical;
a is ½ or 1;
R² is hydrogen, an aliphatic hydrocarbon radical having 1 to 20 carbon atoms, a cycloaliphatic hydrocarbon radical having 5 to 8 carbon atoms, or an optionally substituted aryl radical having 6 to 14 carbon atoms;
Y is O or NR²;
m is 2 to 4; and
n is 0 to 200;
b) 1 to 89 mol % of a structural group of the formula (II) 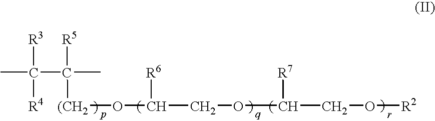
wherein
R³ is H or an aliphatic hydrocarbon radical having 1 to 6 carbon atoms;
R⁴ is an aliphatic hydrocarbon radical having 1 to 6 carbon atoms, a cycloaliphatic hydrocarbon radical having 5 to 8 carbon atoms or phenyl;
R⁵ is H or an aliphatic hydrocarbon radical having 1 to 5 carbon atoms;
R⁶ and R⁷ are each independently selected from H or an aliphatic hydrocarbon radical having 1 to 6 carbon atoms;
p is from 0 to 3;
q+r is from 0 to 500;
and
R² is as defined above;
c) 0 to 10 mol % of at least one structural group of formula (IIIa) or formula (IIIb) 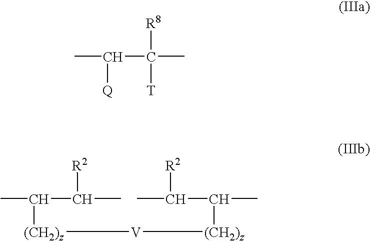
wherein
Q is —H, —COOₐM or —COOR⁹;
T is 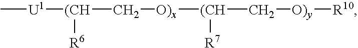
—(CH₂)_{z}—V—(CH₂)_{z}—CH═CH—R², —COOR⁹ if Q is —COOR⁹ or COOₐM;
U¹ is —CO—NH—, —O— or —CH₂O—;
U² or —NH—CO—, —O— or —OCH₂—;
V is —O—CO—C₆H₄—CO—O—;
R⁸ is H or CH₃;
R⁹ is an aliphatic hydrocarbon radical having 3 to 20 carbon atoms, a cycloaliphatic hydrocarbon radical having 5 to 8 carbon atoms or an aryl radical having 6 to 14 carbon atoms;
R¹⁰ is R² or 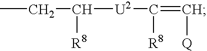
z is from 0 to 4;
x is from 1 to 150;
y is from 0 to 15; and
R², R⁶ and R⁷ are as defined above.

22. A copolymer according to claim 21, further comprising d) 0-50 mol % of a structural group (IV) 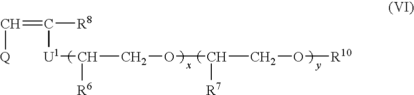
the monomers of which are a vinyl- or (meth)acrylic acid derivative.

23. A copolymer based on unsaturated monocarboxylic or dicarboxylic acid derivatives and oxyalkylene glycol alkenyl ethers, consisting of
a) 10 to 90 mol % of at least one structural group of formula (Ia) or formula (Ib) 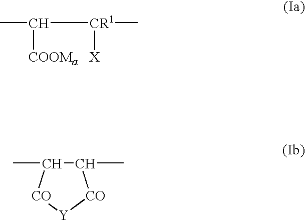
wherein
R¹ is hydrogen or an aliphatic hydrocarbon radical having 1 to 20 carbon atoms;
X is H, —COOMₐ, —CO—O(CₘH₂ₘO)ₙ—R² or —CO—NH—(CₘH₂ₘO)ₙ—R²;
M is hydrogen, a mono- or divalent metal cation, ammonium ion or an organic amine radical;
a is ½ or 1;
R² is hydrogen, an aliphatic hydrocarbon radical having 1 to 20 carbon atoms, a cycloaliphatic hydrocarbon radical having 5 to 8 carbon atoms or an optionally substituted aryl radical having 6 to 14 carbon atoms;
Y is O or NR²;
m is 2 to 4; and
n is 0 to 200;
b) 1 to 89 mol % of a structural group of formula (II) 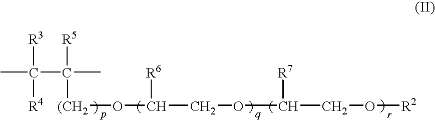
wherein
R³ is H or an aliphatic hydrocarbon radical having 1 to 6 carbon atoms;
R⁴ is an aliphatic hydrocarbon radical having 1 to 6 carbon atoms, a cycloaliphatic hydrocarbon radical having 5 to 8 carbon atoms or phenyl;
R⁵ is H or an aliphatic hydrocarbon radical having 1 to 5 carbon atoms;
R⁶ and R⁷ are each independently selected from H or an aliphatic hydrocarbon radical having 1 to 6 carbon atoms;
p is from 0 to 3;
q+r is from 0 to 500
and
R² is as defined above;
c) from 0 to 10 mol % of at least one structural group of formula (IIIa) or formula (IIIb) 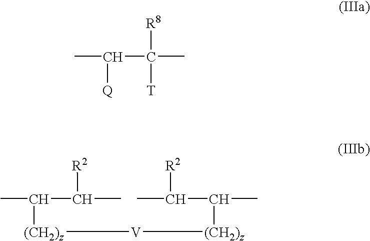
wherein
Q is —H, —COOₐM or —COOR⁹;
T is 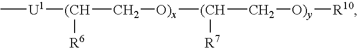
—(CH₂)_{z}—V—(CH₂)_{z}—CH═CH—R², —COOR⁹ if Q or —COOR⁹ or COOₐM;
U¹ is from —CO—NH—, —O— or —CH₂O—;
U² is —NH—CO—, —O— or —OCH₂—;
V is —O—CO—C₆H₄—CO—O—;
R⁸ is H or CH₃;
R⁹ is an aliphatic hydrocarbon radical having 3 to 20 carbon atoms, a cycloaliphatic hydrocarbon radical having 5 to 8 carbon atoms or an aryl radical having 6 to 14 carbon atoms;
R¹⁰ is R² or 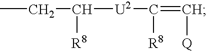
z is 0 to 4;
x is 1 to 150;
y is 0 to 15; and
R², R⁶ and R⁷ are as defined above;
d) from 0-50 mol % of structural group (IV) 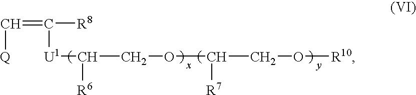
whose monomers are vinyl- or (meth)acrylic acid derivatives.

24. A copolymer according to claim 21, wherein R¹ is hydrogen or a methyl radical.

25. A copolymer according to claim 21, wherein M is a mono- or divalent metal cation selected from the group consisting of sodium, potassium, calcium or magnesium ions.

26. A copolymer according to claim 21, wherein if R² is phenyl substituted with at least one of a hydroxyl, carboxyl or sulphonic acid group.

27. A copolymer according to claim 21, wherein in the formula (II) p is 0.

28. A copolymer according to claim 21, comprising 40 to 75 mol % of the at least one structural group of formula (Ia) or formula (Ib), 20 to 55 mol % of the structural group of formula (II) and 1 to 5 mol % of the at least one structural group of formula (IIIa) or formula (IIIb).

29. A copolymer according to claim 21, further comprising up to 50 mol % based on the sum of the structural groups of formula (Ia), formula (Ib), formula (II), formula (IIIa) and formula (IIb), of structural groups whose monomers are a vinyl- or (meth)acrylic acid derivative.

30. A copolymer according to claim 22, wherein the monomeric vinyl derivative is styrene, α-methylstyrene, vinyl acetate, vinyl propionate, ethylene, propylene, isobutene, N-vinylpyrrolidone, allylsulphonic acid, methallylsulphonic acid, vinylsulphonic acid or vinylphosphonic acid.

31. A copolymer according to claims 22, wherein the monomeric (meth)acrylic acid derivative is hydroxyalkyl (meth)acrylate, acrylamide, methacrylamide, AMPS, methyl methacrylate, methyl acrylate, butyl acrylate or cyclohexyl acrylate.

32. A copolymer according to claim 21 having an average molecular weight of 5,000 to 100,000 g/mol.

33. A copolymer according to claim 23, wherein R¹ is hydrogen or a methyl radical.

34. A copolymer according to claim 23, wherein M is a mono- or divalent metal cation selected from the group consisting of sodium, potassium, calcium or magnesium ions.

35. A copolymer according to claim 23, wherein if R² is phenyl substituted with at least one of a hydroxyl, carboxyl or sulphonic acid group.

36. A copolymer according to claim 23, wherein in the formula (II) p is 0.

37. A copolymer according to claim 23, comprising 40 to 75 mol % of the at least one structural group of formula (Ia) or formula (Ib), 20 to 55 mol % of the structural group of formula (II) and 1 to 5 mol % of the at least one structural group of formula (IIIa) or formula (IIIb).

38. A copolymer according to claim 23, further comprising up to 50 mol % based on the sum of the structural groups of formula (Ia), formula (Ib), formula (II), formula (IIa) and formula (IIb), of structural groups whose monomers are a vinyl- or (meth)acrylic acid derivative.

39. A copolymer according to claim 29, wherein the monomeric vinyl derivative is styrene, α-methylstyrene, vinyl acetate, vinyl propionate, ethylene, propylene, isobutene, N-vinylpyrrolidone, allylsulphonic acid, methallylsulphonic acid, vinylsulphonic acid or vinylphosphonic acid.

40. A copolymer according to claims 29, wherein the monomeric (meth)acrylic acid derivative is hydroxyalkyl (meth)acrylate, acrylamide, methacrylamide, AMPS, methyl methacrylate, methyl acrylate, butyl acrylate or cyclohexyl acrylate.

41. A copolymer according to claim 23 having an average molecular weight of 5,000 to 100,000 g/mol.

42. A process for the preparation of a copolymer according to claim 21, comprising polymerizing 10 to 90 mol % of an unsaturated mono- or dicarboxylic acid derivative, 1 to 89 mol % of an oxyalkylene glycol alkenyl ether, 0 to 10 mol % of a vinylic polyalkylene glycol or ester compound with the aid of a free-radical starter.

43. A process according to claim 42, wherein 40 to 75 mol % of an unsaturated mono- or dicarboxylic acid derivative, 20 to 55 mol % of an oxyalkylene glycol alkenyl ether and 1 to 5 mol % of a vinylic polyalkylene glycol or ester compound are polymerized.

44. A process according to claim 42, further comprising copolymerizing up to 50 mol % based on the monomers having the structural groups of formulae (Ia), (Ib), (II), (IIa) or (IIIb) and (IV), of a vinyl or (meth)acrylic acid derivative are copolymerized.

45. A process according to claim 42, wherein the polymerization is carried out in aqueous solution at a temperature of 20 to 100° C.

46. A process according to claim 45, wherein the concentration of the aqueous solution is 30 to 50% by weight.

47. A process according to claim 42, wherein the polymerization is carried out without solvent with the aid of a free-radical starter at temperatures of 20 to 150° C.

48. An aqueous suspensions based on mineral or bituminous binders, in particular cement, gypsum, lime, anhydrite, or other calcium sulphate-based binder or a pulverulent dispersion binder comprising a binder material and an additive, wherein the additive is a copolymer according to claim 21.

49. The aqueous suspension of claim 48, wherein the additive is present in an amount of from 0.01 to 10% by weight based on the weight of the mineral binder.

50. A process for the preparation of a copolymer according to claim 23, comprising polymerizing 10 to 90 mol % of an unsaturated mono- or dicarboxylic acid derivative, 1 to 89 mol % of an oxyalkylene glycol alkenyl ether, 0 to 10 mol % of a vinylic polyalkylene glycol or ester compound with the aid of a free-radical starter.

51. A process according to claim 50, wherein 40 to 75 mol % of an unsaturated mono- or dicarboxylic acid derivative, 20 to 55 mol % of an oxyalkylene glycol alkenyl ether and 1 to 5 mol % of a vinylic polyalkylene glycol or ester compound are polymerized.

52. A process according to claim 50, further comprising copolymerizing up to 50 mol % based on the monomers having the structural groups of formulae (Ia), (Ib), (II), (IIIa) or (IIIb) and (IV), of a vinyl or (meth)acrylic acid derivative are copolymerized.

53. A process according to claim 50, wherein the polymerization is carried out in aqueous solution at a temperature of 20 to 100° C.

54. A process according to claim 53, wherein the concentration of the aqueous solution is 30 to 50% by weight.

55. A process according to claim 50, wherein the polymerization is carried out without solvent with the aid of a free-radical starter at temperatures of 20 to 150° C.

56. An aqueous suspensions based on mineral or bituminous binders, in particular cement, gypsum, lime, anhydrite, or other calcium sulphate-based binder or a pulverulent dispersion binder comprising a binder material and an additive, wherein the additive is a copolymer according to claim 23.

57. The aqueous suspension of claim 56, wherein the additive is present in an amount of from 0.01 to 10% by weight based on the weight of the mineral binder.
